(19) United States
(12) Patent Application Publication
(10) Pub. No.: US 2025/0069767 A1
(43) Pub. Date: Feb. 27, 2025

(54) REMOTE RESTART SYSTEM OF VITRIFICATION FACILITY AND METHOD FOR OPERATING SAME

(71) Applicant: KOREA HYDRO & NUCLEAR POWER CO., LTD, Gyeongju-si Gyeongsangbuk-do (KR)

(72) Inventors: Young Hwan HWANG, Daejeon (KR); Cheon Woo KIM, Daejeon (KR); Seok Ju HWANG, Daejeon (KR); Deuk Man KIM, Daejeon (KR)

(73) Assignee: KOREA HYDRO & NUCLEAR POWER CO., LTD, Gyeongju-si Gyeongsangbuk-do (KR)

(21) Appl. No.: 18/721,019

(22) PCT Filed: Jan. 2, 2023
(86) PCT No.: PCT/KR2023/000030

§ 371 Date: Jun. 17, 2024

(30) Foreign Application Priority Data
Jan. 4, 2022 (KR) 10-2022-0000755

(51) Int. Cl. G21F 9/30

(52) U.S. Cl. CPC G21F 9/305

(57) ABSTRACT

Provided are a remote restart system for vitrification equipment and a method of operating the same. The method of operating the remote restart system for the vitrification equipment includes: operating the vitrification equipment; and having power loss in the vitrification equipment, wherein the power loss occurs during or before operation of the vitrification equipment, the remote restart system assists in restarting the vitrification equipment when the power loss occurs in the vitrification equipment, and the remote restart system includes a low-temperature melting furnace, glass frit provided inside the low-temperature melting furnace, a titanium ring for heating the glass frit inside the low-temperature melting furnace, and a bar-shaped handling unit put into the low-temperature melting furnace to handle the glass frit to a state suitable for reignition of the glass frit.

### TECHNICAL FIELD

The present disclosure relates to a remote restart system for vitrification equipment and a method of operating the same.

### BACKGROUND ART

In order to start a low-temperature melting furnace of vitrification equipment, a titanium (Ti) ring must be placed horizontally, and glass frit must be properly distributed around the titanium ring. The initial glass loading and the titanium ring placement can be done by a worker in close proximity to ensure proper placement. However, in order to restart the vitrification equipment when the vitrification equipment is stopped for reasons such as temporary power loss, it is essential to place the titanium ring horizontally and distribute the glass frit properly from a distance through a gate of the vitrification equipment.

### DISCLOSURE

### Technical Problem

Aspects of the present disclosure are to effectively restart a low-temperature melting furnace which has been stopped in situations such as power loss of vitrification equipment for treating radioactive waste.

Aspects of the present disclosure are also to properly place and operate a titanium ring and glass frit input through an upper gate of a low-temperature melting furnace.

Aspects of the present disclosure are also to efficiently achieve an initial ignition operation by placing glass frit in an optimal shape around a titanium ring.

Aspects of the present disclosure are also to properly control a titanium ring and glass frit from a distance in order to prevent radiation exposure to a worker when working close to vitrification equipment for treating radioactive waste.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

### Technical Solution

According to an aspect of the present disclosure, there is provided a method of operating a remote restart system for vitrification equipment. The method includes: operating the vitrification equipment; and having power loss in the vitrification equipment, wherein the power loss occurs during or before operation of the vitrification equipment, the remote restart system assists in restarting the vitrification equipment when the power loss occurs in the vitrification equipment, the vitrification equipment includes a low-temperature melting furnace, glass frit provided inside the low-temperature melting furnace and a titanium ring for heating the glass frit inside the low-temperature melting furnace, and the remote restart system includes a bar-shaped handling unit put into the low-temperature melting furnace to handle the glass frit to a state suitable for reignition of the glass frit.

In addition, the titanium ring is provided in a first state in which the titanium ring is positioned to accommodate a first region of the glass frit in a central portion thereof, and the handling unit brings about a second state in which the glass frit of at least the first region is positioned in a second region around the first region by physically handling the first region in the central portion of the titanium ring.

In addition, in the second state, the glass frit is positioned in the second region centered on the first region at a higher level than the glass frit of the first region.

In addition, in the second state, the glass frit is positioned such that the glass frit of the first region covers at least the titanium ring.

In addition, the glass frit of the second region is formed to form an inclined surface having any one of uniform, non-uniform, and rounded shapes.

In addition, the handling unit includes a bar-shaped body portion and a contact portion installed on the body portion and used to handle the glass frit of the first region, and the contact portion handles the glass frit based on rotation in at least a circumferential direction from the body portion.

In addition, further including a guide module for guiding the position of the handling unit put into the low-temperature melting furnace, wherein at least any one of the body portion and the contact portion of the handling unit includes a metal material, and the guide module is installed in the low-temperature melting furnace or around the low-temperature melting furnace to generate a magnetic force within a set range and, when the handling unit is put into the low-temperature melting furnace, guides the handling unit to be placed at a preset initial position of the handling unit based on the magnetic force so that the glass frit can be handled.

In addition, the vitrification equipment further includes a level detection module which detects the state of the glass frit inside the low-temperature melting furnace, and the level detection module includes a photographing module which detects the state of the glass frit and a level detection module which detects the level of the glass frit.

In addition, the handling unit has a size that does not exceed at least a diameter of an inner circumferential surface of the handling unit so that the handling unit can enter the central portion of the titanium ring.

According to another aspect of the present disclosure, there is provided a remote restart system for vitrification equipment. The vitrification equipment includes a low-temperature melting furnace, glass frit provided inside the low-temperature melting furnace and a titanium ring for heating the glass frit inside the low-temperature melting furnace, and the remote restart system includes a bar-shaped handling unit put into the low-temperature melting furnace to handle the glass frit to a state suitable for reignition of the glass frit. Power loss occurs before or during operation of the vitrification equipment, and the remote restart system includes a bar-shaped handling unit put into the low-temperature melting furnace when the power loss occurs in the vitrification equipment to handle the glass frit to a state suitable for reignition of the glass frit.

### Advantageous Effects

The present disclosure provides at least one of the following advantages.

The present disclosure can effectively restart a low-temperature melting furnace which has been stopped in situations such as power loss of vitrification equipment for treating radioactive waste.

In addition, it is possible to properly place and operate a titanium ring and glass frit input through an upper gate of a low-temperature melting furnace.

In addition, it is possible to efficiently achieve an initial ignition process by placing glass frit in an optimal shape around a titanium ring.

In addition, it is possible to properly control a titanium ring and glass frit from a distance in order to prevent radiation exposure to a worker when working close to vitrification equipment for treating radioactive waste.

### DESCRIPTION OF DRAWINGS

FIG. 1 is a schematic diagram illustrating components of a remote restart system for vitrification equipment according to an embodiment of the present disclosure;

FIGS. 2 through 4 are diagrams illustrating states in which glass frit according to FIG. 1 is handled; and

FIG. 5 is a flowchart sequentially illustrating a method of operating a remote restart system for vitrification equipment according to an embodiment of the present disclosure.

### MODE FOR INVENTION

Hereinafter, exemplary embodiments of the present disclosure will be described in further detail with reference to the attached drawings. Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the present disclosure to those skilled in the art, and the present disclosure will only be defined by the appended claims. Like reference numerals refer to like elements throughout the specification.

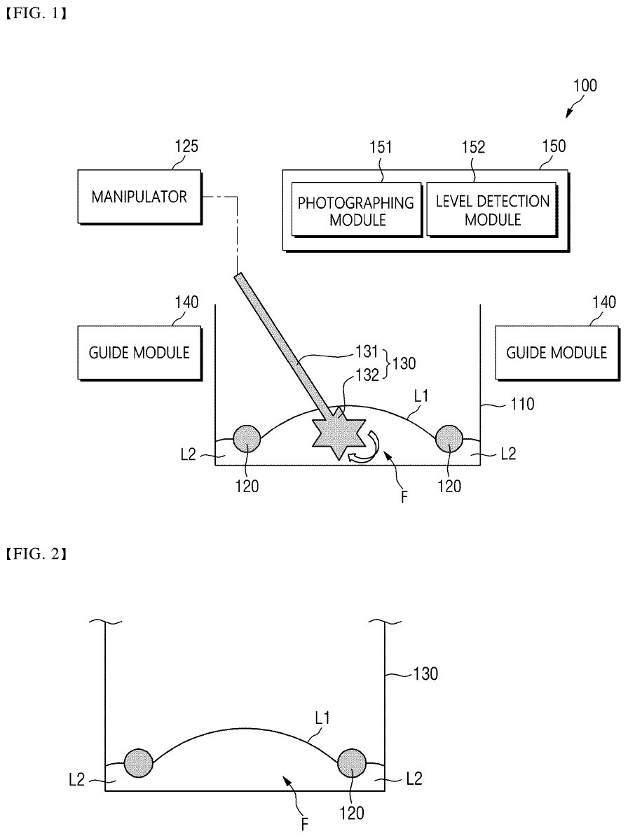

Referring to FIG. 1, a remote restart system for vitrification equipment according to an embodiment of the present disclosure includes a low-temperature melting furnace 110, glass frit F, a titanium ring 120, a manipulator 125, a handling unit 130, a guide module 140, and a state detection module 150.

In addition, the handling unit 130 includes a body portion 131 and a contact portion 132. The state detection module 150 includes a photographing module 151 and a level detection module 152. The low-temperature melting furnace 110 is provided in a predetermined shape for each type.

The glass frit F is provided inside the low-temperature melting furnace 110. The titanium ring 120 is provided inside the low-temperature melting furnace 110 to heat the glass frit F.

The handling unit 130 is put into the low-temperature melting furnace 110. In addition, the handling unit 130 includes a bar shape for handling the glass frit F to a state suitable for reignition of the glass frit F.

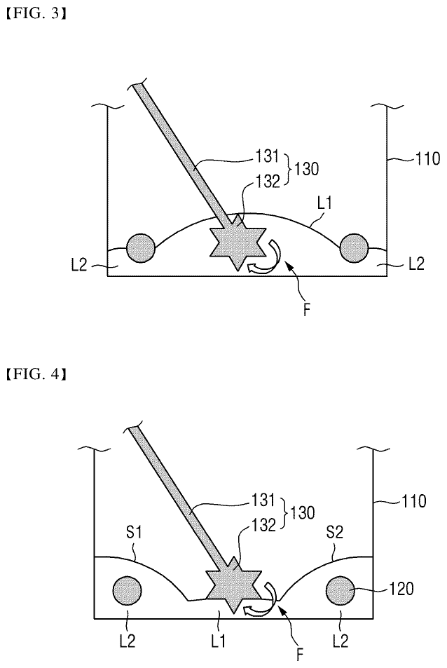

Referring to FIG. 2, the titanium ring 120 is provided in a first state in which it is positioned to accommodate a first region L1 of the glass frit F in its central portion. Here, the handling unit 130 is provided for physical handling of the first region L1 in the central portion of the titanium ring 120.

Referring to FIG. 3, the handling unit 130 is provided, for example, to bring about a second state in which the glass frit F of at least the first region L1 is positioned in a second region L2 around the first region L1.

In the second state, the glass frit F is positioned in the second region L2 centered on the first region L1 at a higher level than the glass frit F of the first region L1.

In addition, in the second state, the glass frit F is positioned such that the glass frit F of the first region L1 covers at least the titanium ring 120. The glass frit F of the second region L2 is formed to form an inclined surface having any one of uniform, non-uniform, and rounded shapes.

Referring to FIG. 1, the body portion 131 of the handling unit 130 includes a bar shape. The contact portion 132 of the handling unit 130 is installed on the body portion 131. The contact portion 132 serves to handle the glass frit F of the first region L1.

The contact portion 132 handles the glass frit F based on rotation in at least a circumferential direction from the body portion 131. The guide module 140 serves to guide the position of the handling unit 130 put into the low-temperature melting furnace 110.

The handling unit 130 is provided such that at least one of the body portion 131 and the contact portion 132 includes a metal material. The guide module 140 is installed in the low-temperature melting furnace 110 or around the low-temperature melting furnace 110 to generate a magnetic force within a set range.

Here, the manipulator 125 may control the operation of the handling unit 130 by being linked to the handling unit 130. The manipulator 125 controls the handing unit 130 while located outside the low-temperature melting furnace 110.

When the handling unit 130 is put into the low-temperature melting furnace 110 for the physical handling, the guide module 140 guides the handling unit 130 to be placed at a preset initial position of the handling unit 130 based on at least any one magnetic force from among an attractive force and a repulsive force.

The state detection module 150 of the vitrification equipment detects the state of the glass frit F inside the low-temperature melting furnace. The photographing module 151 of the state detection module 150 detects the state of the glass frit F.

In addition, the level detection module 152 of the state detection module 150 serves to detect the level of the glass frit F. The handling unit 130 has a size that does not exceed at least a diameter of an inner circumferential surface of the handling unit 130 so that it can enter the central portion of the titanium ring 120.

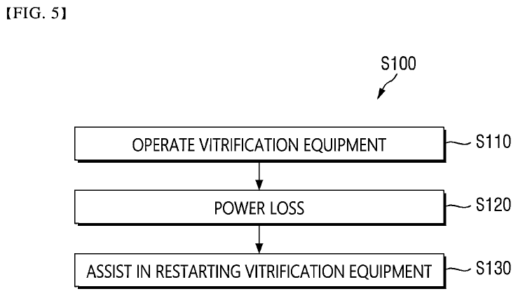

Referring to FIG. 5, in a method of operating a remote restart system for vitrification equipment according to an embodiment of the present disclosure, the vitrification equipment is operated. Here, power loss occurs in the vitrification equipment.

The power loss includes power loss that occurs before as well as during operation of the vitrification equipment. The remote restart system assists in restarting the vitrification equipment when the power loss occurs in the vitrification equipment.

The remote restart system 100 includes a low-temperature melting furnace 110, glass frit F provided inside the low-temperature melting furnace 110, a titanium ring 120 for heating the glass frit F inside the low-temperature melting furnace 110, and a bar-shaped handling unit 130 put into the low-temperature melting furnace 110 to handle the glass frit F to a state suitable for reignition of the glass frit F.

While the present disclosure has been particularly shown and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

1. A method of operating a remote restart system for vitrification equipment, the method comprising:
operating the vitrification equipment; and
having power loss in the vitrification equipment,
wherein the power loss occurs during or before operation of the vitrification equipment, the remote restart system assists in restarting the vitrification equipment when the power loss occurs in the vitrification equipment, and the remote restart system comprises a low-temperature melting furnace, glass frit provided inside the low-temperature melting furnace, a titanium ring for heating the glass frit inside the low-temperature melting furnace, and a bar-shaped handling unit put into the low-temperature melting furnace to handle the glass frit to a state suitable for reignition of the glass frit.

2. The method of claim 1, wherein the titanium ring is provided in a first state in which the titanium ring is positioned to accommodate a first region of the glass frit in a central portion thereof, and the handling unit brings about a second state in which the glass frit of at least the first region is positioned in a second region around the first region by physically handling the first region in the central portion of the titanium ring.

3. The method of claim 2, wherein in the second state, the glass frit is positioned in the second region centered on the first region at a higher level than the glass frit of the first region.

4. The method of claim 2, wherein in the second state, the glass frit is positioned such that the glass frit of the first region covers at least the titanium ring.

5. The method of claim 4, wherein the glass frit of the second region is formed to form an inclined surface having any one of uniform, non-uniform, and rounded shapes.

6. The method of claim 2, wherein the handling unit comprises a bar-shaped body portion and a contact portion installed on the body portion and used to handle the glass frit of the first region, and the contact portion handles the glass frit based on rotation in at least a circumferential direction from the body portion.

7. The method of claim 1, further comprising a guide module for guiding the position of the handling unit put into the low-temperature melting furnace, wherein at least any one of the body portion and the contact portion of the handling unit comprises a metal material, and the guide module is installed in the low-temperature melting furnace or around the low-temperature melting furnace to generate a magnetic force within a set range and, when the handling unit is put into the low-temperature melting furnace, guides the handling unit to be placed at a preset initial position of the handling unit based on the magnetic force so that the glass frit can be handled.

8. The method of claim 4, wherein the vitrification equipment further comprises a level detection module which detects the state of the glass frit inside the low-temperature melting furnace, and the level detection module comprises a photographing module which detects the state of the glass frit and a level detection module which detects the level of the glass frit.

9. has a size that does not exceed at least a diameter of an inner circumferential surface of the handling unit so that the handling unit can enter the central portion of the titanium ring.

10. A remote restart system for vitrification equipment, the system comprising:
a low-temperature melting furnace;
glass frit provided inside the low-temperature melting furnace;
a titanium ring for heating the glass frit inside the low-temperature melting furnace; and
a bar-shaped handling unit put into the low-temperature melting furnace to handle the glass frit to a state suitable for reignition of the glass frit.
